(19) United States
(12) Patent Application Publication
(10) Pub. No.: US 2005/0199796 A1
(43) Pub. Date: Sep. 15, 2005

(54) Charged particle manipulation

(76) Inventor: Frederick John Currell, Belfast (IE)

Correspondence Address: TAFT, STETTINIUS & HOLLISTER LLP, SUITE 1800, 425 WALNUT STREET, CINCINNATI, OH, 45202-3957, US

(21) Appl. No.: 10/524,912

(22) PCT Filed: Aug. 22, 2003
(86) PCT No.: PCT/GB03/03683

§ 371 Date: May 27, 2005

(30) Foreign Application Priority Data
Aug. 27, 2002 (GB) 0219872.9

(51) Int. Cl. H01J 49/00

(52) U.S. Cl. 250/281

(57) ABSTRACT

Methods and apparatus are provided for manipulating the phase space of at least one charged particle, wherein a combination of alternating current and direct current voltages applied to an electrode forms a potential which provides a region of phase space manipulation, and wherein the at least one charged particle is situated to one side of the electrode surface. A number of applications are applicable, which include a spot trap, a conveyor belt, a funnel, and ways of holding different types of particles at different distances from an array so that they can be manipulated.

The present invention relates to the manipulation of charged particles, in particular to methods and apparatus for manipulating the phase space of at least one charged particle.

Trapping of charged particles has a wide range of potential applications including frequency standards, quantum computation, quantum encryption and material processing/fabrication.

However, there is a need for such applications to be easier to realise.

According to a first aspect of the present invention there is provided a method for manipulating the phase space of at least one charged particle, wherein a combination of alternating current and direct current voltages applied to an electrode forms a potential which provides a region of phase space manipulation, and wherein the at least one charged particle is situated to one side of the electrode surface.

According to a second aspect of the present invention, there is provided apparatus for manipulating the phase space of at least one charged particle, comprising at least one electrode arranged on a surface and connected to a power supply capable of applying both an alternating current voltage and a direct current voltage so as to form a potential which provides a region of phase space manipulation to one side of the electrode surface.

Preferably, the apparatus further comprises pressure control means to control the pressure of the space surrounding the electrodes.

Preferably, the pressure control means comprises a sealable chamber and gas pump means capable of introducing and extracting gases from the chamber.

Preferably, the power supply is operable to vary the alternating current and direct current voltages applied.

Preferably, the power supply is operable to individually alter the amplitude, waveform, and frequency of the alternating current voltage, and is operable to alter the magnitude of the direct current voltage.

Preferably, the potential is an effective potential.

Preferably, the region of phase space manipulation comprises a particle trapping region, wherein a particle is constrained in a specific spatial area.

Preferably, the region of phase space manipulation comprises a particle guide region, wherein a particle's motion is restrained by at least one degree of freedom.

Preferably, a plurality of electrodes are provided.

Preferably, the electrodes are arranged in an array such that the at least one particle is situated to one side of the array.

Preferably, the array is substantially planar.

Alternatively, the array is hemispherical.

According to a first embodiment of the present invention, a single electrode is provided, and is surrounded by a plane held at a constant potential.

Preferably, the electrode is circular.

Preferably, the plane is earthed.

Preferably, the frequency of alternating current voltage applied to the circular electrode is of a frequency having a period that is less than the time taken for light to pass over the diameter of the circular electrode.

According to a second embodiment of the present invention, the voltages applied to adjacent first and second sets of electrodes in a planar array can be varied such that the at least one particle can be moved from the particle trapping region provided by the first set of electrodes to the particle trapping region provided by the second set of electrodes.

Each set of electrodes may consist of one electrode, or of a plurality of electrodes.

Preferably, at least one particle is moved from a first trapping region provided by a first set of electrodes to a second trapping region provided by a second set of electrodes, wherein the voltages applied to the sets of electrodes is changed from an initial, to an intermediate and then to a final configuration, and wherein;
in an initial configuration, a first set of electrodes is biased to a holding voltage to form a first particle trapping region to trap at least one particle therein, and an adjacent second set of electrodes is biased to zero volts;
in an intermediate configuration, both sets of electrodes are biased to the holding voltage to form a merged particle trapping region that traps the at least one particle;
in a final configuration, the first set of electrodes is biased to zero volts, and the second set of electrodes is biased to the holding voltage to form a second particle trapping region, that traps the at least one particle.

Preferably, the process of moving at least one particle from a first trapping region provided by a first set of electrodes to a second trapping region provided by a second set of electrodes is repeatable to move the at least one particle along a chosen path on the planar array.

The planar array can be formed using printed circuit board, lithographic, or focussed ion beam technology.

According to a third embodiment of the present invention, a series of electrodes are provided, the voltages applied to which are controllable such that the at least one particle can be moved from a first particle trapping region to a second particle trapping region, wherein the first trapping region is larger than the second trapping region.

Preferably, the voltages applied to the electrodes are controllable such that the at least one particle can be moved between a plurality of successively smaller trapping regions.

Preferably, the series of electrodes comprises a plurality of concentrically arranged circular electrodes.

Preferably, in an initial state, every electrode has a combination of alternating current and direct current voltages applied such that at least one particle is trapped in a first trapping region;
the voltage applied to the outer electrode is changed such that, in an intermediate state, the at least one particle is trapped in a first intermediate trapping region provided by the remaining inner electrodes; and
the voltage applied to the electrode adjacent to the outer electrode is changed such that in a final state, the at least one particle is trapped in a second trapping region provided by the innermost electrode.

Preferably, in the transitions from the initial to intermediate and the intermediate to final states, the outer and adjacent electrodes respectively are set to zero volts.

Preferably, a plurality of electrodes each provide a further intermediate trapping region, such that, between the initial state and the final state, the at least one particle passes through a plurality of intermediate states, being trapped in successively smaller intermediate trapping regions.

Preferably, in an initial state, an outermost electrode has a first combination of alternating current and direct current voltages applied, and a background voltage is applied to the remaining electrodes such that, in an initial state, at least one particle is trapped in a first trapping region;
the electrode adjacent to the outer electrode is set to the first combination of voltages and the background voltage is applied to the outer electrode such that, in an intermediate state, the at least one particle is trapped in a first intermediate trapping region; and
the innermost electrode is set to the first combination of voltages and the background voltage is applied to the adjacent electrode such that, in a final state, the at least one particle is trapped in a second trapping region.

Preferably, the background voltage is zero volts.

Preferably, a plurality of electrodes is provided such that, between the initial state and the final state, the at least one particle passes through a plurality of intermediate states, being trapped in successively smaller intermediate trapping regions.

Preferably, the innermost electrode is provided with an aperture; and
when the at least one particle is in the final state, a voltage is applied to the aperture such that the at least one particle is urged through the aperture.

Preferably, each side of the aperture is differentially pumped so that a gas passing through the aperture undergoes a supersonic expansion, so as to cool the particles that are urged through the aperture.

According to a fourth embodiment of the present invention, the voltages applied to an electrode are such that one type of charged particle can be distinguished from another.

Preferably, different types of charged particle are trapped at different distances perpendicularly from the surface of the electrode.

Preferably, the distance is dependent on the charge and/or mass of the charged particle.

Preferably, a first type of charged particle is trapped at a first perpendicular distance from the electrode, and a second type of charged particle is trapped at a second perpendicular distance from the electrode, wherein the mass of the first charged particle is greater than the mass of the second charged particle, and the second perpendicular distance is greater than the first perpendicular distance.

Preferably, at least one particle trapped at the second perpendicular distance is subject to the potential formed by a voltage sequence applied to a second set of electrodes.

Preferably, the voltage sequence applied to the second set of electrodes is such as to transport said at least one particle from one trapping region to another along a predetermined path.

Preferably, the dimensions of the second set of electrodes are of a much larger scale than the dimensions of the trap electrode.

Preferably, an aperture is provided on an electrode such that the type of particle that is closest to the surface of the electrode can pass through the aperture.

Preferably, each side of the aperture is differentially pumped so that a gas passing through the aperture undergoes a supersonic expansion, so as to cool the particles that are urged through the aperture.

According to a fifth embodiment of the present invention, the voltages applied to an electrode can be changed such that a trapped particle moves in a direction perpendicular to the plane of the electrode.

Preferably, at least one trapped particle can be lowered to a region where it will interact with at least one other particle; and
the particles that result from the interaction can then be raised up again, together with particles that have not interacted.

Preferably, the electrode is formed with an aperture and the applied voltage can be changed to bring a particle close to the aperture; and
a voltage is applied to the aperture such that the particle is urged through the aperture.

Preferably, each side of the aperture is differentially pumped so that a gas passing through the aperture undergoes a supersonic expansion, so as to cool the particles that are urged through the aperture.

According to a sixth embodiment of the present invention, an array of electrodes is provided, the voltages applied to which trap a first type of particle which can interact with a second type of particle, to form a reactant particle which falls to the bottom of a trap and is swept away through an extraction hole.

According to a further aspect of the present invention, there is provided apparatus for carrying out the method of the sixth embodiment, comprising an array of electrodes arranged on a surface, at least one of which is connected to at least one power supply capable of applying both an alternating current voltage and a direct current voltage, wherein a region of phase space manipulation is provided to one side of the electrode surface.

Preferably, the array of electrodes further comprises at least one aperture for the extraction of trapped particles.

Preferably, each electrode comprises one aperture.

Preferably, the reactant particle is accelerated through a potential and detected so that the position of the original first type of particle can be detected.

The present invention will now be described, by way of example only, with reference to the accompanying drawings, in which:

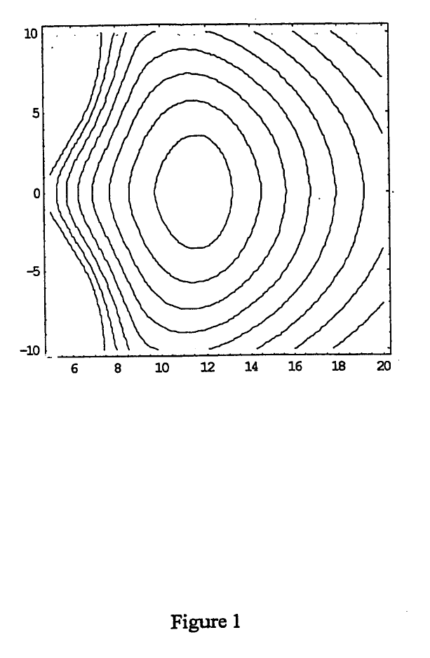

FIG. 1 illustrates potential contours suitable for trapping a charged particle formed by an electrode in accordance with a first embodiment of the invention;

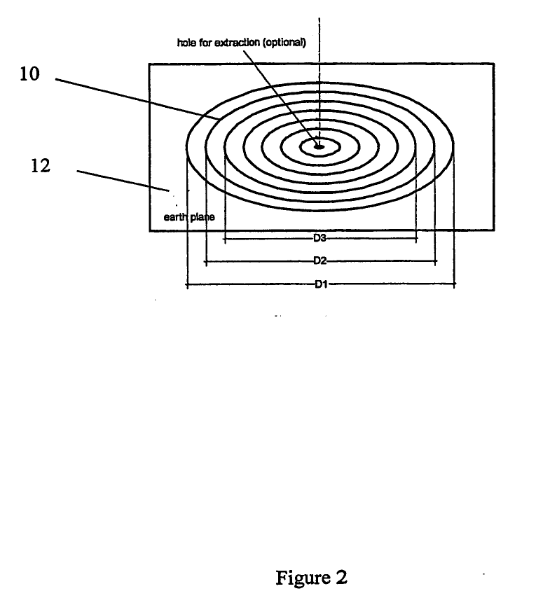

FIG. 2 illustrates a third embodiment of the invention;

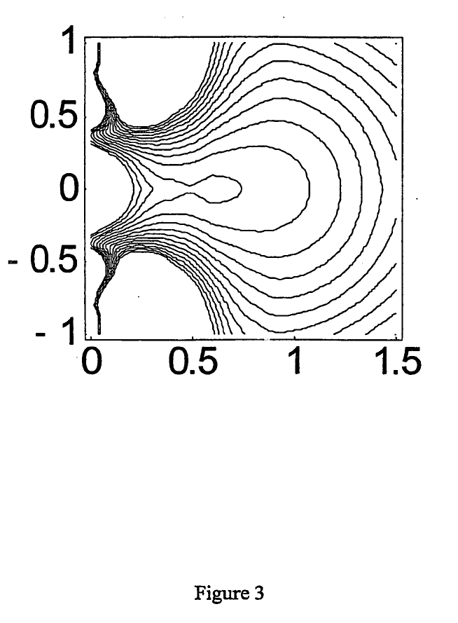

FIG. 3 illustrates potential contours where a particle will not be trapped;

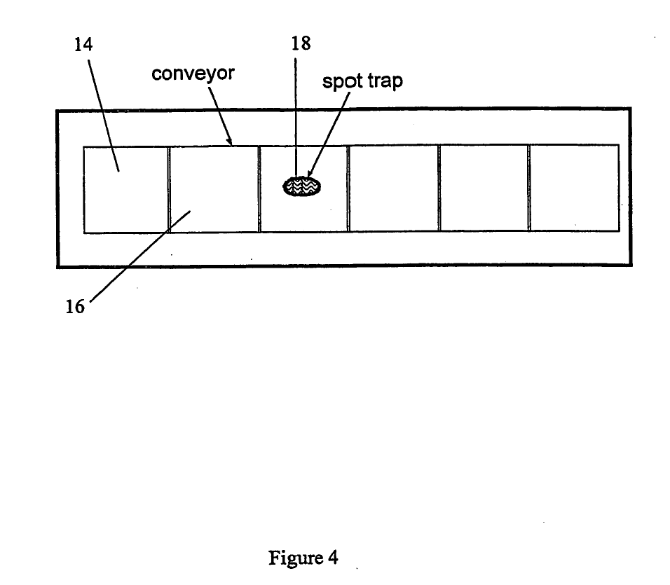

FIG. 4 illustrates a fourth embodiment of the present invention;

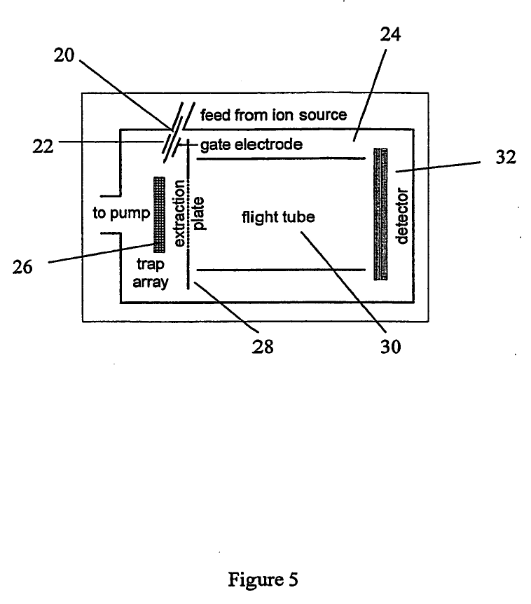

FIG. 5 illustrates apparatus used in accordance with all embodiments of the invention; and

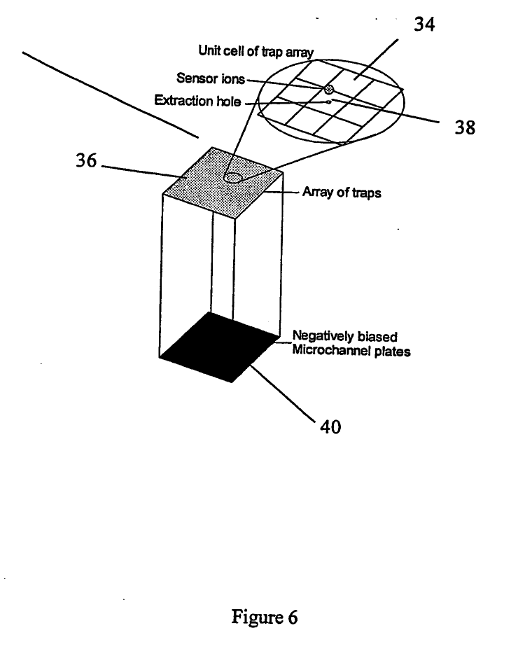

FIG. 6 illustrates a sixth embodiment of the invention.

In the adiabatic approximation, a particle of mass m and charge q subject to a set of DC and rapidly varying AC voltages (angular frequency Ω) applied to a series of electrodes moves as if subject to an effective potential V* which is a linear combination of an AC term and a DC term, and takes the form
V*(R₀)=q²E₀²/4mΩ²+qΦₛ (1)
where E₀ is the E-field due to the AC voltages, Φₛ is the electrostatic potential due to the DC voltages and R₀ is the position of an ion averaged over several cycles of the AC voltage.

With respect to an electrode, the AC part is always repulsive whereas the DC part can be either attractive or repulsive.

A DC system alone cannot trap ions since the potential has a negative curvature in at least one direction. However, the combination of AC and DC voltages results in an effective potential that at some locations has a positive curvature in all directions such that charged particles can be trapped.

Equation (1) above can be re-cast as
V*(R₀)=qV_{dc}(kE₀²+Φₛ) (2)
where a factor of q has been dropped through conversion to electron-volts for the units of potential and by considering singly charged ions (although the system described here is not subject to that limitation). k has the value
k=qγ²/4mΩ² (3)
where γ is a scaling parameter for the AC voltages applied to the system of electrodes, compared to the DC voltage applied, defined explicitly by γ=V_{ac}/(V_{dc}l), where V_{ac} and V_{dc} are the actual voltages applied to the electrodes and l gives the length-scale associated with the whole design.

The variable k thus serves as a parameter which can illustrate the scaling of a potential. For a specific trapped particle, γ or Ω can be varied. The variables q and m are specific to the particle that is trapped.

Thus, in contrast to known particle trapping or guiding techniques, the present invention provides for the trapping or guiding of particles where the trapping electrodes do not have to surround the particle. The electrodes can be arranged in any suitable formation. One option would be for them to lie in a plane. Other options are possible; in particular, the electrodes may be in an array which is substantially planar, but in which some are at relatively raised or lowered positions. The electrodes may also be arranged, for example, in a hemispherical, ellipsoidal or paraboloid configuration.

In a first embodiment, a spot trap is provided. A single electrode is surrounded by a large earth plane. The system is readily scalable through appropriate scaling of the value of k.

Provided the AC voltage is applied at a frequency sufficiently low to ensure light can travel across the system in a time much less than one period, the potential due to the AC voltage is simply that due to the DC voltage but modulated in time.

FIG. 1 is a plot of the potential contours for a specific trapping configuration of a circular electrode. In this system, a 10 μm radius spot was chosen and had a DC voltage of −1V applied to it with respect to the earth plane. The value of the scaling parameter k was chosen to be 100.

The horizontal ordinate is the perpendicular distance from the electrode plane and the vertical ordinate the radial distance from the symmetry axis, both in μm. The minimum of the effective potential (located at approximately r=0 μm, z=11 μm) has a value of −0.186V with respect to the surrounding earth plane. Contours are shown for −0.18 to −0.11V in 0.01V intervals.

Because the system concerned has cylindrical symmetry about an axis passing through the centre of the circular electrode and perpendicular to the plane it is sufficient to demonstrate the resultant effective potential has the form required to trap particles in one plane passing through the symmetry axis to demonstrate the system is an ion trap. It can therefore be seen that this is a trapping configuration.

Numerical tests have shown that the system traps ions for a range of values of k greater than about 80.

The distance of the trap centre from the surface and the curvature at the bottom of the trap can be changed by changing the value of k. In particular, as the value of k is increased, particles of a given mass will be trapped at a point more distant from the plane of the electrode. As k is dependent on a particle's mass, it follows that, for a given value of k, particles of heavier mass will lie closer to the plane of the electrode. Furthermore, as k increases, the curvature of the bottom of the potential well changes, resulting in a larger sized and differently shaped trapping region. Note that this change in the trapping region is distinct from the change in trapping region brought about by funnelling techniques disclosed below, where the shape of the trapping region remains constant.

The ion will remain trapped in the trapping region provided the adiabaticity parameter is small enough.

It is given by

$$η = \frac{2 q \vert ∇ {E}_{0} \vert}{m {Ω}^{2}} . \qquad ( 4 )$$

Experiments have shown that this parameter must have a value of less than 0.3 for stable trapping. Tests indicate this parameter will have a value of about 0.05 near the minimum of the effective potential so the trapping is expected to be stable. Further numerical tests can be made to verify this assertion and to determine the volume over which stable trapping occurs.

This principle is not restricted to a simple circular trapping electrode. For example, a matrix of electrodes could be fabricated. The voltages applied to the various electrodes can then be chosen to manipulate particles in a number of ways, some of which are illustrated below.

For example, in a second embodiment, the voltages applied to the various electrodes in an array could be chosen for example so that all of those lying inside a given region are biased with an appropriate DC voltage and an AC voltage with the remaining electrodes being biased to zero volts. Gradually changing the location of the region inside which the biased electrodes reside (i.e. changing electrodes successively from being biased to being at earth and the other way in a systematic fashion) corresponds to moving the trap location across the surface, effectively creating a particle conveyor belt. In a third embodiment, the electrodes can act as a funnel, the voltages being varied so as to bring trapped particles from a wide area to be concentrated in a central region.

An example of an electrode configuration that can act as a funnel is shown in FIG. 2. A series of concentric electrodes 10 is provided, which initially all have the same AC and DC voltages applied. They are surrounded by a large earth plane 12. Thus, in an initial state, the system looks like a spot-trap, with a diameter equal to D1, and k set to a particular value. After some time in this configuration, the outer electrode would be set to 0V (making it seem like part of the earth plane), whilst the waveform applied to the others would be changed to keep k at the same predetermined value (note l has changed because the diameter of the spot is equal D2). There is then a first intermediate state, where the effective potential now has the same form, but is slightly shrunk in comparison to the potential in the initial state. Thereafter, successive electrodes are grounded from the outside in, always keeping k constant, until a final state is reached where the particle is trapped by the central electrode.

An alternative way of funnelling a particle may be to provide the same electrode structure; but initially only have the outer few rings with voltages applied, with those inside being earthed. Then, moving successively from the outside, each electrode is set to zero while one more inner has voltages applied. Thus, the particles are again focussed in a central region.

The innermost electrode can be provided with an aperture, which acts as an extraction hole. As seen above, for smaller values of k, the particles are trapped closer to the surface of the electrodes. As k is reduced further, the potential ceases to act as a trapping potential. At a certain value of k, (found to be 77.7 for the specific spot trap mentioned above), the trap “breaks” and a trapped particle can escape. The potential contours at this point are illustrated in FIG. 3. A biased extraction electrode can optionally be provided on the other side of the aperture.

When the system is used with a buffer gas, the two sides of the extraction region can be differentially pumped so that the buffer gas going through the aperture undergoes a supersonic expansion so that the beam of particles passing through the aperture is cooled.

In a fourth embodiment, the abovementioned spot trap and conveyor belt configurations can be combined to provide manipulation of particles, where particles of differing mass or charge can be separated and treated differently.

The scaling parameter, k, is inversely proportional to the mass of the trapped particles, so that more massive particles are trapped closer to the surface of an electrode. FIG. 4 shows a configuration where a series of conveyor electrodes 14 is provided, forming a conveyor 16, to which the voltages applied allows the conveyor 16 to transport particles from one trapping region to another. A spot trap electrode structure 18 is situated in the middle of the conveyor 16.

The relative length scales of the conveyor electrodes 14 and the spot trap electrodes 18 are such that the conveyor electrodes 14 are much larger than the spot trap electrodes 18. When a relatively light particle is trapped by the spot trap 18, it is trapped at such a height that, due to the local nature of the e-field and potential, it is more influenced by the potential of the conveyor 16 than the spot trap 18.

Hence, one can envisage a system where (possibly after some interaction) particles arrange themselves at different distances from the surface depending on their masses. The less massive particles would then rise up and be swept away by a conveyor belt, with the heavier particles remaining in the trap region.

After such a process, the remaining heavier particles could be passed through an extraction hole, using the methods described above.

Alternatively, one might be interested in a process where the particle mass increases. In this case the trap could initially be programmed to hold both the mass before and after an interaction. It then could be periodically programmed to have a lower value of k so the lighter (unchanged) particles rise up to be transported to a holding zone. The trap could then become part of a conveyor belt, perpendicular to the direction the lighter particles were moved. The heavier (changed) particles would then be transported away for further processing after which the lighter particles could be returned (possibly with others added) to the interaction region.

In a fifth embodiment, where particles are trapped at a certain height, the value of the scaling parameter k can be decreased such that the particles are lowered towards the electrode surface to interact with other particles deposited there. The value of k can then be increased again so that the product particles, and any unchanged particles can be raised up.

In all of the above embodiments, printed circuit board technology can be used to construct the electrode arrays. The proximity of adjacent electrodes is limited by cross talk effect, but the nature of the interactions should be such that useful devices can be constructed for the transportation of various particles, such as, for example, ions or electrons.

Indeed, there are many technologies for forming such arrays, such as focussed ion beam or lithographic techniques. The choice of construction method will depend on the length scale and application of the particular array to be constructed.

The above concepts have a wide range of potential applications. In particular, the techniques above may be used to enable miniaturisation and parallelisation of current techniques for frequency standards, quantum computation, quantum encryption and material analysis.

In addition, the techniques are directly applicable to the manufacture of devices for manipulating ions, for use in high end biomolecular experiments.

It will be appreciated that the electrodes of an apparatus, which are connected to an appropriate power supply, will normally be contained within a sealable chamber, and a gas pump is provided to introduce and extract gas in order to vary the pressure and control the quality of vacuum provided in the chamber.

FIG. 5 shows an apparatus that uses the techniques of the present invention, which is particularly intended to be used with biomolecular ions.

Ions 20 are introduced into a chamber 24. Optional gate electrodes 22 are used to control the introduction of the ions 20. The ions 20 are used to seed an array of trap electrodes 26.

A pump and gas inlet valve (not shown) control the introduction and extraction of a background buffer gas, to control the vacuum provided by the chamber 24.

The voltages applied to the array 26 can be varied to manipulate ions 20, as described above. At any time, the trapping voltages can be switched off and an extraction voltage can be applied to an extraction plate 28 to accelerate the ions 20 through a flight tube 30 towards a position-sensitive detector 32. Although the ions 20 may undergo several collisions in the flight tube 30 these collisions will be brief and with the much lighter buffer gas partners. Accordingly these collisions should not destroy the positional or time-of-flight information.

Time-of flight will be used to distinguish genuinely trapped or guided ions 20 from background ions so the time-gated image on the position-sensitive detector 32 corresponds to a snap-shot of the ion 20 locations just prior to the application of the extraction voltage.

It will be appreciated that trapped ions have a thermal energy distribution that means they will have a finite chance of escaping, much as a water molecule has a chance of evaporating from a liquid below the boiling point. When such a trapped particle escapes, it passes through the aperture. However, as the voltages are varied, this shall occur slightly before the normally expected transmission time of that particular particle. The times when a particle may escape outside of these transmission times will depend on the values and rate of changes of the amplitude, waveform, and frequency of the voltages applied. Thus, the mass of the particle can be determined by correlating the time of passage through the aperture with the state of the trap at that time.

Various buffer gas collision regimes can be explored, particularly the high collision frequency limit (useful for material processing and working with Biomolecules) and the collisionless limit (useful for quantum computation and encryption). In the high frequency limit the ions will rapidly become thermalised through collisions with background gas and one another. This background can be a rare gas buffer so no unwanted chemical reactions occur, or it could be, for example, water to investigate hydration of biomolecules. A rare gas buffer can easily be cooled to liquid N2 temperature when the characteristic energy associated with each degree of freedom will be about 3 meV so the trapped ions will lie inside the trapping region, which is seen as the innermost contour of FIG. 1.

The details of the dynamics in the collisionless limit are harder to calculate although this can be done using certain computer simulation techniques.

For a given voltage configuration the motion of a single ion can be approximated by a superposition of harmonic motions, which may be coupled.

Another device that can be constructed using the principles of the invention is a single reconfigurable trap. This can be a few centimetres across, with circular electrodes centred about an extraction region consisting of a small aperture with the trap system to one side and a biased extraction electrode to the other side. For such a trap, the effective potential takes the form shown in FIG. 1. The effective potential contours are chosen so that the innermost contour corresponds to room temperature, compared to the minimum.

The trap will be gradually reconfigured so that the length scale gradually reduces from about 3 cm to 50 μm, so all of the ions trapped in the potential are gathered into a successively smaller volume, similar to a deflating balloon.

The trapping nature will then be changed so that the ions are free to move towards the extraction region, centred at the origin. The potential will take the form shown in FIG. 3 (note change in z-axis), when the trapped ions will escape through the extraction region. The two sides of the extraction region can be differentially pumped so the buffer gas going through the aperture will undergo a supersonic expansion giving further cooling to the beam of biomolecular ions.

The resultant pulsed source of cold biomolecular ions will be ideal for investigating their reactive scattering behaviour, hence creating a new and topical research field.

The principles of the present invention can also be used to construct a position-sensitive detector, which is illustrated in FIG. 6.

An array of traps 34 forms a planar electrode structure 36 and is loaded with a specific molecular ion (A⁺) chosen to be able to react associatively with a particular biomolecule or class of biomolecules (B). The choice of A⁺ relates to the specificity of the detector. A microchannel plate 40 is provided, the front surface of which is biased highly negatively to attract the positive ions. Alternatively, any suitable position sensitive charged particle detector may be used in place of a microchannel plate.

When a molecule B approaches the planar structure 36 it can then react with one of the sensor molecule ions in the associative reaction:
A⁺+B→AB⁺ (5)

The trap configuration is arranged so that the product ion, being more massive falls towards the electrode surface 36 eventually being swept through due to a field penetrating through one of an array of small holes 38. This penetrating field occurs as a natural consequence of biasing the front surface of the microchannel plates 40 highly negative. Note that the same effect could be achieved by having the back face of the electrode array being negatively charged. The ion is then accelerated from the hole 38 towards a microchannel plate 40, which will be the front-end of a traditional position sensitive detector (something akin to an image intensifier). The resultant detection event provides a record of the position of the biomolecule prior to the interaction.

It may additionally be possible to cycle the trapping so that the more massive product ions are held in the trap and can only reach the penetrating field periodically. In this case, time-of-flight information can be used to determine the mass of the product ion and hence determine the mass of A⁺ as well as the class of molecules to which it belongs.

The innate capability of the trapping array to store different ions at different locations could be exploited to store different species A⁺ at different locations, making the system able to distinguish a range of biomolecules (B) simultaneously.

A bespoke CAD/simulation package can also be provided to aid in the design of arrays to trap or guide charged particles. For a given trap configuration subject to any sequence of applied voltages, the motion of trapped ions can in principle be solved exactly through solution of Maxwell's equations for the fields and Newton's equations for the motion of the ions. However, this might be computationally intractable for the scale of problems envisaged.

Because of the length and frequency scales involved, linear combinations of solutions of Laplace's equation can be used in place of the full solution of Maxwell's equations. This problem is computationally tractable for arbitrary geometries and, due to the near-symmetries of the trap arrays proposed, amenable to further speed-ups through multi-resolution analysis. Using solutions of Laplace's equation obtained in this manner, the properties of the trapping or guiding arrays will be deduced by solving the dynamics of the trapped ions at various levels of approximation ranging from full explicit solution of the motion of trapped ions coupled to a Monte-Carlo simulation for collisions with the buffer gas (computationally expensive) to simply calculating the effective trapping potential averaged over a particular ‘trapping sequence’ of applied voltages and then using statistical distributions and friction models for the ions subject to this effective potential (computationally cheap).

Such simulations will first be used to assess the range of validity of computationally cheap strategies. Once this is established, the effective potential and adiabaticity parameter for various trap/guide configurations and ‘trapping sequences’ will be used to predict their behaviour.

Control of the program will be achieved through a visual interface, leading to a bespoke CAD/simulation program for ion trap/guide arrays, which can be made available to researchers in the field, and can act over an array of PC's acting as a parallel computer. Both the solution of Laplace's equation and the calculation of trajectories are amenable to parallel computation.

Various modifications can be made without departing from the scope of the present invention. In particular, the charged particles may comprise ions, electrons, or any other suitable charged particles.

The fabrication of the electrode arrays may be by any suitable means, of which printed circuit board technology, lithographic methods, and focussed ion beam methods are examples only.

The shape of electrodes in each embodiment may take any suitable shape, and the examples given should not be taken as limiting these to any particular shape. For example, a funnel configuration could be implemented by means of a series of concentric circular electrodes. These electrodes could be ellipsoidal, square, or any other suitable shape.

The voltages applied to the electrodes may take any suitable form, and can be modulated before being sent to the electrodes. For example, the voltages could be square waves to enable digital logic techniques to be used when processing the information. Furthermore, the voltages applied to the electrodes can be of appropriate polarity to attract or repel specific particles. For example, in the apparatus for carrying out the method of the sixth embodiment, the microchannel plate is biased negatively. However, it could be charged positively to attract negative particles.

It will also be acknowledged that in configurations such as the conveyor belt, their operation is described in terms of actually transporting particles; however the voltage sequences can be applied even when no particles are present, so that the conveyor configuration may be always active, to transport particles as and when they are present.

It will also be appreciated that specific applications of the principles of the invention may be applied in combination.

1. Apparatus for manipulating the phase space of at least one charged particle, comprising at least one electrode arranged on a surface and connected to a power supply capable of applying both an alternating current voltage and a direct current voltage so as to form a potential which provides a region of phase space manipulation to one side of the electrode surface wherein said electrode or electrodes do not surround a charged particle whose phase space is manipulated in use.

2. The apparatus of claim 1, further comprising pressure control means to control the pressure of the space surrounding the electrodes.

3. The apparatus of claim 2, wherein the pressure control means comprises a sealable chamber and gas pump means capable of introducing and extracting gases from the chamber.

4. The apparatus of claim 1, wherein the power supply is operable to vary the alternating current and direct current voltages applied.

5. The apparatus of claim 4, wherein the power supply is operable to individually alter the amplitude, waveform, and frequency of the alternating current voltage, and is operable to alter the magnitude of the direct current voltage.

6. The apparatus of claim 1, wherein the potential is an effective potential.

7. The apparatus of claim 1, wherein the region of phase space manipulation comprises a particle trapping region, wherein a particle is constrained in a specific spatial area.

8. The apparatus of claim 1, wherein the region of phase space manipulation comprises a particle guide region, wherein a particle's motion is restrained by at least one degree of freedom.

9. The apparatus of claim 8, wherein a plurality of electrodes are provided.

10. The apparatus of claim 9, wherein the electrodes are arranged in an array such that the at least one particle is situated to one side of the array.

11. The apparatus of claim 10, wherein the array is substantially planar.

12. The apparatus of claim 10, wherein the array is hemispherical.

13. The apparatus of claim 1, wherein a single electrode is provided, and is surrounded by a plane held at a constant potential.

14. The apparatus of claim 13, wherein the electrode is circular.

15. The apparatus of claim 14, wherein the plane is earthed.

16. The apparatus of claim 15, wherein the frequency of alternating current voltage applied to the circular electrode is of a frequency having a period that is less than the time taken for light to pass over the diameter of the circular electrode.

17. The apparatus of claim 1, wherein the voltages applied to adjacent first and second sets of electrodes in a planar array can be varied such that the at least one particle can be moved from the particle trapping region provided by the first set of electrodes to the particle trapping region provided by the second set of electrodes.

18. The apparatus of claim 17, wherein at least one particle can be moved from a first trapping region provided by a first set of electrodes to a second trapping region provided by a second set of electrodes, wherein the voltages applied to the sets of electrodes can be changed from an initial, to an intermediate and then to a final configuration, and wherein;
in an initial configuration, a first set of electrodes is biased to a holding voltage to form a first particle trapping region to trap at least one particle therein, and an adjacent second set of electrodes is biased to zero volts;
in an intermediate configuration, both sets of electrodes are biased to the holding voltage to form a merged particle trapping region that traps the at least one particle;
in a final configuration, the first set of electrodes is biased to zero volts, and the second set of electrodes is biased to the holding voltage to form a second particle trapping region, that traps the at least one particle.

19. The apparatus of claim 18, wherein the process of moving at least one particle from a first trapping region provided by a first set of electrodes to a second trapping region provided by a second set of electrodes is repeatable to move the at least one particle along a chosen path on the planar array.

20. The apparatus of claim 19, wherein the planar array is formed using printed circuit board, lithographic, or focussed ion beam technology.

21. The apparatus of claim 1, wherein a series of electrodes are provided, the voltages applied to which are controllable such that the at least one particle can be moved from a first particle trapping region to a second particle trapping region, wherein the first trapping region is larger than the second trapping region.

22. The apparatus of claim 21, wherein the voltages applied to the electrodes are controllable such that the at least one particle can be moved between a plurality of successively smaller trapping regions.

23. The apparatus of claim 22, wherein the series of electrodes comprises a plurality of concentrically arranged circular electrodes.

24. The apparatus of claim 21, wherein, in an initial state, every electrode has a combination of alternating current and direct current voltages applied such that at least one particle is trapped in a first trapping region;
the voltage applied to the outer electrode can be changed such that, in an intermediate state, the at least one particle is trapped in a first intermediate trapping region provided by the remaining inner electrodes; and
the voltage applied to the electrode adjacent to the outer electrode can be changed such that in a final state, the at least one particle is trapped in a second trapping region provided by the innermost electrode.

25. The apparatus of claim 24, wherein, in the transitions from the initial to intermediate and the intermediate to final states, the outer and adjacent electrodes respectively are set to zero volts.

26. The apparatus of claim 25, wherein a plurality of electrodes each provide a further intermediate trapping region, such that, between the initial state and the final state, the at least one particle passes through a plurality of intermediate states, being trapped in successively smaller intermediate trapping regions.

27. The apparatus of claim 21, wherein, in an initial state, an outermost electrode has a first combination of alternating current and direct current voltages applied, and a background voltage is applied to the remaining electrodes such that, in an initial state, at least one particle is trapped in a first trapping region;
the electrode adjacent to the outer electrode can be set to the first combination of voltages and the background voltage is applied to the outer electrode such that, in an intermediate state, the at least one particle is trapped in a first intermediate trapping region; and
the innermost electrode can be set to the first combination of voltages and the background voltage is applied to the adjacent electrode such that, in a final state, the at least one particle is trapped in a second trapping region.

28. The apparatus of claim 27, wherein the background voltage is zero volts.

29. The apparatus of claim 27, wherein a plurality of electrodes is provided such that, between the initial state and the final state, the at least one particle passes through a plurality of intermediate states, being trapped in successively smaller intermediate trapping regions.

30. The apparatus of claim 23, wherein the innermost electrode is provided with an aperture; arranged such that:
when the at least one particle is in the final state, a voltage is applied to the aperture such that the at least one particle is urged through the aperture.

31. The apparatus of claim 30, wherein each side of the aperture is differentially pumped so that a gas passing through the aperture undergoes a supersonic expansion, so as to cool the particles that are urged through the aperture.

32. The apparatus of claim 1, wherein the voltages applied to an electrode are such that one type of charged particle can be distinguished from another.

33. The apparatus of claim 32, wherein different types of charged particle are trapped at different distances perpendicularly from the surface of the electrode.

34. The apparatus of claim 33, wherein the distance is dependent on the charge and/or mass of the charged particle.

35. The apparatus of claim 34, wherein a first type of charged particle is trapped at a first perpendicular distance from the electrode, and a second type of charged particle is trapped at a second perpendicular distance from the electrode, wherein the mass of the first charged particle is greater than the mass of the second charged particle, and the second perpendicular distance is greater than the first perpendicular distance.

36. The apparatus of claim 35, wherein at least one particle trapped at the second perpendicular distance is subject to the potential formed by a voltage sequence applied to a second set of electrodes.

37. The apparatus of claim 36, wherein the voltage sequence applied to the second set of electrodes is such as to transport said at least one particle from one trapping region to another along a predetermined path.

38. The apparatus of claim 36, wherein the dimensions of the second set of electrodes are of a much larger scale than the dimensions of the trap electrode.

39. The apparatus of claim 32, wherein an aperture is provided on an electrode such that the type of particle that is closest to the surface of the electrode can pass through the aperture.

40. The apparatus of claim 39, wherein each side of the aperture is differentially pumped so that a gas passing through the aperture undergoes a supersonic expansion, so as to cool the particles that are urged through the aperture.

41. The apparatus of claim 1, wherein the voltages applied to an electrode can be changed such that a trapped particle moves in a direction perpendicular to the plane of the electrode.

42. The apparatus of claim 41, wherein at least one trapped particle can be lowered to a region where it will interact with at least one other particle; and
the particles that result from the interaction can then be raised up again, together with particles that have not interacted.

43. The apparatus of claim 42, wherein the electrode is formed with an aperture and the applied voltage can be changed to bring a particle close to the aperture; and
a voltage is applied to the aperture such that the particle is urged through the aperture.

44. The apparatus of claim 43, wherein each side of the aperture is differentially pumped so that a gas passing through the aperture undergoes a supersonic expansion, so as to cool the particles that are urged through the aperture.

45. The apparatus of claim 41, wherein an array of electrodes is provided, the voltages applied to which trap a first type of particle which can interact with a second type of particle, to form a reactant particle which falls to the bottom of a trap and is swept away through an extraction hole.

46. The apparatus of claim 45, wherein the array of electrodes further comprises at least one aperture for the extraction of trapped particles.

47. The apparatus of claim 46, wherein each electrode comprises one aperture.

48. The apparatus of claim 47, wherein the reactant particle is accelerated through a potential and detected so that the position of the original first type of particle can be detected.

49. A method for manipulating the phase space of at least one charged particle, wherein a combination of alternating current and direct current voltages applied to an electrode forms a potential which provides a region of phase space manipulation, and wherein the at least one charged particle is situated to one side of the electrode surface, wherein said electrode or electrodes do not surround a charged particle whose phase space is manipulated in use.

50. The method of claim 49, further comprising the step of controlling the pressure of the space surrounding the electrodes.

51. The method of claim 50, wherein the pressure control means comprises a sealable chamber and gas pump means capable of introducing and extracting gases from the chamber.

52. The method of claim 49, wherein the power supply is operable to vary the alternating current and direct current voltages applied.

53. The method of claim 52, wherein the power supply is operable to individually alter the amplitude, waveform, and frequency of the alternating current voltage, and is operable to alter the magnitude of the direct current voltage.

54. The method of claim 49, wherein the potential is an effective potential.

55. The method of claim 49, wherein the region of phase space manipulation comprises a particle trapping region, wherein a particle is constrained in a specific spatial area.

56. The method of claim 49, wherein the region of phase space manipulation comprises a particle guide region, wherein a particle's motion is restrained by at least one degree of freedom.

57. The method of claim 56, wherein a plurality of electrodes are provided.

58. The method of claim 57, wherein the electrodes are arranged in an array such that the at least one particle is situated to one side of the array.

59. The method of claim 58, wherein the array is substantially planar.

60. The method of claim 58, wherein the array is hemispherical.

61. The method of claim 49, wherein a single electrode is provided, and is surrounded by a plane held at a constant potential.

62. The method of claim 61, wherein the electrode is circular.

63. The method of claim 61, wherein the plane is earthed.

64. The method of claim 62, wherein the frequency of alternating current voltage applied to the circular electrode is of a frequency having a period that is less than the time taken for light to pass over the diameter of the circular electrode.

65. The method of claim 49, wherein the voltages applied to adjacent first and second sets of electrodes in a planar array can be varied such that the at least one particle can be moved from the particle trapping region provided by the first set of electrodes to the particle trapping region provided by the second set of electrodes.

66. The method of claim 65, wherein at least one particle is moved from a first trapping region provided by a first set of electrodes to a second trapping region provided by a second set of electrodes, wherein the voltages applied to the sets of electrodes is changed from an initial, to an intermediate and then to a final configuration, and wherein;
in an initial configuration, a first set of electrodes is biased to a holding voltage to form a first particle trapping region to trap at least one particle therein, and an adjacent second set of electrodes is biased to zero volts;
in an intermediate configuration, both sets of electrodes are biased to the holding voltage to form a merged particle trapping region that traps the at least one particle;
in a final configuration, the first set of electrodes is biased to zero volts, and the second set of electrodes is biased to the holding voltage to form a second particle trapping region, that traps the at least one particle.

67. The method of claim 66, wherein the process of moving at least one particle from a first trapping region provided by a first set of electrodes to a second trapping region provided by a second set of electrodes is repeatable to move the at least one particle along a chosen path on the planar array.

68. The method of claim 67, wherein the planar array is formed using printed circuit board, lithographic, or focussed ion beam technology.

69. The method of claim 49, wherein a series of electrodes are provided, the voltages applied to which are controllable such that the at least one particle can be moved from a first particle trapping region to a second particle trapping region, wherein the first trapping region is larger than the second trapping region.

70. The method of claim 69, wherein the voltages applied to the electrodes are controllable such that the at least one particle can be moved between a plurality of successively smaller trapping regions.

71. The method of claim 70, wherein the series of electrodes comprises a plurality of concentrically arranged circular electrodes.

72. The method of claim 71, wherein, in an initial state, every electrode has a combination of alternating current and direct current voltages applied such that at least one particle is trapped in a first trapping region;
the voltage applied to the outer electrode is changed such that, in an intermediate state, the at least one particle is trapped in a first intermediate trapping region provided by the remaining inner electrodes; and
the voltage applied to the electrode adjacent to the outer electrode is changed such that in a final state, the at least one particle is trapped in a second trapping region provided by the innermost electrode.

73. The method of claim 72, wherein, in the transitions from the initial to intermediate and the intermediate to final states, the outer and adjacent electrodes respectively are set to zero volts.

74. The method of claim 72, wherein a plurality of electrodes each provide a further intermediate trapping region, such that, between the initial state and the final state, the at least one particle passes through a plurality of intermediate states, being trapped in successively smaller intermediate trapping regions.

75. The method of claim 69, wherein, in an initial state, an outermost electrode has a first combination of alternating current and direct current voltages applied, and a background voltage is applied to the remaining electrodes such that, in an initial state, at least one particle is trapped in a first trapping region;
the electrode adjacent to the outer electrode is set to the first combination of voltages and the background voltage is applied to the outer electrode such that, in an intermediate state, the at least one particle is trapped in a first intermediate trapping region; and
the innermost electrode is set to the first combination of voltages and the background voltage is applied to the adjacent electrode such that, in a final state, the at least one particle is trapped in a second trapping region.

76. The method of claim 75, wherein the background voltage is zero volts.

77. The method of claim 75, wherein a plurality of electrodes is provided such that, between the initial state and the final state, the at least one particle passes through a plurality of intermediate states, being trapped in successively smaller intermediate trapping regions.

78. The method of claim 71, wherein the innermost electrode is provided with an aperture; and
when the at least one particle is in the final state, a voltage is applied to the aperture such that the at least one particle is urged through the aperture.

79. The method claim 78, wherein each side of the aperture is differentially pumped so that a gas passing through the aperture undergoes a supersonic expansion, so as to cool the particles that are urged through the aperture.

80. The method of claim 49, wherein the voltages applied to an electrode are such that one type of charged particle can be distinguished from another.

81. The method of claim 80, wherein different types of charged particle are trapped at different distances perpendicularly from the surface of the electrode.

82. The method of claim 81, wherein the distance is dependent on the charge and/or mass of the charged particle.

83. The method of claim 82, wherein a first type of charged particle is trapped at a first perpendicular distance from the electrode, and a second type of charged particle is trapped at a second perpendicular distance from the electrode, wherein the mass of the first charged particle is greater than the mass of the second charged particle, and the second perpendicular distance is greater than the first perpendicular distance.

84. The method of claim 83, wherein at least one particle trapped at the second perpendicular distance is subject to the potential formed by a voltage sequence applied to a second set of electrodes.

85. The method of claim 84, wherein the voltage sequence applied to the second set of electrodes is such as to transport said at least one particle from one trapping region to another along a predetermined path.

86. The method of claim 85, wherein the dimensions of the second set of electrodes are of a much larger scale than the dimensions of the trap electrode.

87. The method of claim 80, wherein an aperture is provided on an electrode such that the type of particle that is closest to the surface of the electrode can pass through the aperture.

88. The method of claim 87, wherein each side of the aperture is differentially pumped so that a gas passing through the aperture undergoes a supersonic expansion, so as to cool the particles that are urged through the aperture.

89. The method of claim 49, wherein the voltages applied to an electrode can be changed such that a trapped particle moves in a direction perpendicular to the plane of the electrode.

90. The method of claim 89, wherein at least one trapped particle can be lowered to a region where it will interact with at least one other particle; and
the particles that result from the interaction can then be raised up again, together with particles that have not interacted.

91. The method of claim 89, wherein the electrode is formed with an aperture and the applied voltage can be changed to bring a particle close to the aperture; and
a voltage is applied to the aperture such that the particle is urged through the aperture.

92. The method of claim 91, wherein each side of the aperture is differentially pumped so that a gas passing through the aperture undergoes a supersonic expansion, so as to cool the particles that are urged through the aperture.

93. The method of claim 89, wherein an array of electrodes is provided, the voltages applied to which trap a first type of particle which can interact with a second type of particle, to form a reactant particle which falls to the bottom of a trap and is swept away through an extraction hole.

94. The method of claim 93, wherein the array of electrodes further comprises at least one aperture for the extraction of trapped particles.

95. The method of claim 94, wherein each electrode comprises one aperture.

96. The method of claim 95, wherein the reactant particle is accelerated through a potential and detected so that the position of the original first type of particle can be detected.
